(19) United States
(12) Patent Application Publication
(10) Pub. No.: US 2022/0219476 A1
(43) Pub. Date: Jul. 14, 2022

(54) DECORATING GUITARS WITH UV TRANSFER PROCESS

(71) Applicant: PS Business Services, LLC, Boulder, CO (US)

(72) Inventors: Stephen Spurgeon, Boulder, CO (US); Robert J. Ross, Niwot, CO (US)

(21) Appl. No.: 17/574,220

(22) Filed: Jan. 12, 2022

Related U.S. Application Data
(60) Provisional application No. 63/136,627, filed on Jan. 12, 2021.

(51) Int. Cl. B41M 5/025; B41M 7/00; B41J 3/407

(52) U.S. Cl. CPC B41M 5/0256; G10D 1/08; B41J 3/4073; B41M 7/0081

(57) ABSTRACT

A transfer method utilizing partially cured radiation sensitive ink to transfer a onto a contoured or uneven surface area of a guitar body by a transfer method. Specifically, a transfer material has a surface that is printed with a radiation sensitive ink. The desired design may be printed to the surface and partially cured by exposing the radiation sensitive ink to appropriate radiation. Thereafter, the surface of the transfer material may be brought into facing engagement with the contoured surface of the guitar body such that the printed and partially cured design is disposed between the contoured surface and the transfer material. The design may be transferred to the contoured surface by, for example, application of pressure to an opposite side of the transfer material using a burnisher or the like. Once transferred, the design may be fully cured by exposing the now transferred radiation sensitive ink to appropriate radiation.

### CROSS-REFERENCE TO RELATED APPLICATIONS

The present application claims benefit of priority to U.S. Provisional Patent Application No. 63/136,627, entitled “DECORATING GUITARS WITH UV TRANSFER PROCESS” filed on 12 Jan. 2021, which is specifically incorporated by reference herein for all that it discloses or teaches.

### BACKGROUND

It may be advantageous to allow for application of a design or other decoration to the body of a guitar or other musical instrument. For example, often times guitar bodies are painted from the factory. However, customization of the designs or decorations applied to the guitar may help provide added interest to the instrument and increase the value of the guitar through such customizations. In turn, efforts have been made to provide custom direct printing of designs or other decorations non guitar bodies.

However, proposed direct printing processes may only allow for only partial printing on a surface of many guitars. Specifically, direct surface printing onto a guitar body may be limited to printing in flat areas of the guitar. This may be due to the spray pattern of ink-jet type printers that require a constant distance between the ink-jet print head and the surface to be printed. Thus, traditional two axis control of a print head does not allow the print head to print on surfaces at different distances from the print head. However, many guitar bodies have a curved element to the contour of the body (e.g., the Stratocaster® and Telecaster® guitars provided by Fender Musical Instruments Corporation of Scottsdale, Ariz.). In turn, direct surface printing on such guitars with contoured portions may be limited to printing in flat surfaces of the guitar body.

### SUMMARY

In view of the foregoing, the present disclosure is directed to techniques for application of designs or decorations to a guitar body including to curved or contoured portions of the guitar body. The present disclosure includes a method for application of a design to a contoured surface of a guitar in which a transfer material having a surface may be provided. A design may be applied to a surface of a transfer material with a printing apparatus using a UV radiation sensitive ink. The UV radiation sensitive ink may be exposed to UV light after the UV radiation sensitive ink has been applied to the surface of the transfer material to partially cure the UV radiation sensitive ink. In turn, the surface of the transfer material may be disposed in facing relation to the contoured surface to dispose the design between the surface and the contoured surface such that the design may be transferred to the contoured surface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example guitar to which a design may be applied.

FIG. 2 illustrates an example of a printing apparatus that prints to a transfer material.

FIG. 3 illustrates another example of a printing apparatus that includes a bed on which a material to be printed is disposed.

FIG. 4 illustrates a side-view of an example ink-jet print head.

FIG. 5 illustrates an example of transfer of a design from a transfer material to a guitar body.

FIG. 6 illustrates another example of transfer of a design from a transfer material to a guitar body.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

As noted above, it may be desired to provide designs or other decorations onto the body of music instruments such as guitars or the like. Specifically, custom designs applied to such instruments may increase the value or appeal of the instrument to an owner or potential purchaser of the instrument. However, it may be difficult to apply decorations using direct surface printing because such musical instruments often have contoured portions of the surface to be printed. Such surfaces may be difficult to direct print using existing approaches that often require a constant distance between a print head and the surface to be printed. In addition, such printing approaches often employ only two-dimensional control over a print head such that the distance between the print head and the surface to be printed cannot be varied. As such, it may not be possible to direct print designs onto contoured portions of the guitar body.

While described in the context of a contoured surface of a guitar body, the transfer printing process described herein may be used to print any type of contoured surface on which traditional two axis printing devices may not directly print. This may include a guitar or other musical instrument as described herein. In addition, the present disclosure may be used to print a guitar shaped game controller or the like. In this regard, while described particularly in the context of a guitar body, the present disclosure may be used to print any contoured surface of a musical instrument or other object.

The present disclosure utilizes a transfer material to apply a design to a contoured surface of a music instrument. Specifically, the present disclosure contemplates use of radiation sensitive inks (e.g., UV sensitive inks). For example, the radiation sensitive ink may be directly printed onto a transfer material while maintaining the transfer material at a constant distance from the print head. This may allow for traditional printing of a design onto the transfer material. The radiation sensitive ink may be exposed to radiation to partially cure the radiation sensitive ink once printed onto the transfer material. Such partial curing may stabilize the printed design on the transfer material and allow the transfer material to be moved without disrupting the design printed thereon. In turn, the transfer material may be disposed relative to the guitar body such that the design printed onto the transfer material is disposed between a contoured surface of the guitar body and the surface of the transfer material on which the design is printed. Pressure may be applied to a side of the transfer material opposite the printed surface such that the printed design comprising the partially cured radiation sensitive ink is transferred from the transfer material to the contoured surface of the guitar. The application of pressure to the opposite side of the transfer material may be referred to as a rub down process. Once the partially cured radiation sensitive ink comprising the design is transferred to the guitar body, the radiation sensitive ink may be exposed to sufficient radiation to fully cure the radiation ink, thus providing a stable design on the surface of the guitar.

This disclosure refers to a design throughout. It may be appreciated that a design as referred to herein may color graphics, patterns, photography, or other indicia. The design may comprise decorations such as custom decorations. In some examples, the design may comprise a photograph or other image. As will be described in greater detail below any digital image may be printed onto a transfer material and transferred to a contoured surface to provide sharp, bright, and very colorful images, patterns, and other decorations on the front and/or back of a guitar, thus producing a very attractive product

In some examples, the decorations comprising the design may be selected by an owner or purchaser of the guitar. In other examples, the design may be selected by a manufacturer of the guitar. Further still, while described as being applied to a guitar or a guitar body herein, it may be appreciated that the approaches described herein may be used to apply a design to other types of stringed musical instruments, other types of musical instruments (e.g., brass instruments, woodwind instruments, etc.), or to any other type of contoured surface. The methods and process may greatly advance the art of decorating guitars and other musical instruments. In addition, the decorations may help to simulate and increase interest and participation in purchasing and playing guitars and other musical instruments for a wide range of consumers.

In addition, the techniques described in the present disclosure may be used in conjunction with a direct printing process. For instance, a guitar body may comprise both a flat surface portion and a contoured surface portion. In this regard, the flat surface portion may be directly printed using, for example, any of the disclosures of U.S. Pat. No. 7,895,967 entitled DECORATING GUITARS issued on Mar. 1, 2011; U.S. Pat. No. 7,470,455 entitled DECORATING GUITARS issued on Dec. 30, 2008, U.S. Pat. No. 7,736,706 entitled DECORATING GUITAR SHAPED ARTICLES issued on Jun. 15, 2010, U.S. Pat. No. 7,737,349 entitled DECORATING GUITARS issued on Jun. 15, 2010, or U.S. application Ser. No. 17/393,072 entitled CONTOUR SURFACE PRINTING filed on Aug. 3, 2021, each of which is incorporated by reference in its entirety.

Also, the contoured surface portion may have a design provided on it by using one or more of the example techniques described herein. Moreover, the combined use of direct surface printing of the flat surface portion and the transfer printing approach of the contoured surface portion may be used to each print a portion of a unified design. That is, the two separate processes to print the flat surface portion and the contoured surface portion may be used in conjunction to print a unified design that may extend to both the flat surface portion and the contoured surface portion. As such, upon completion of the two printing processes, a single design may span both the flat surface portion and the contoured surface portion such that the design appears to have been unitarily printed.

In this regard, the radiation sensitive ink used in the transfer printing process described herein may also be used in a direct surface printing of other portions of the guitar body. In one example, the radiation sensitive ink comprises a crosslinked UV sensitive ink. Such UV sensitive inks may be cross-compatible with existing topcoats, base coats, and protective coatings commonly used with guitar bodies. In addition, the chemical makeup of inks used in direct printing as well as the radiation sensitive ink used in the transfer process described herein may be cross compatible and crosslink with no separation of layers. This may allow union of the two types of imagery through two different modes of application as described above.

As used herein, the term transfer material is used in relation to any and all iterations of the process of transferring a design onto a surface (e.g., the surface of a Stratocaster® guitar body or neck). The transfer material may comprise any appropriate material including, for example, polymer sheets, paper sheets, coated paper sheets, or any other material that may be used as a carrier for printing and partially curing a design thereon. The transfer material may be flexible so as to conform to the contoured surface of the guitar body. The transfer material may be selected to have relatively limited adhesion to the radiation sensitive inks even when partially cured. By relatively limited adhesion, it is meant that the partially cured radiation sensitive ink may have a greater affinity for the guitar body than the transfer material such that once the partially cured radiation sensitive ink is disposed between the guitar body and the transfer material, the radiation sensitive ink will adhere to the guitar body more readily than the transfer material such that the transfer material may be removed to leave behind the partially cured radiation sensitive ink in place on the guitar body.

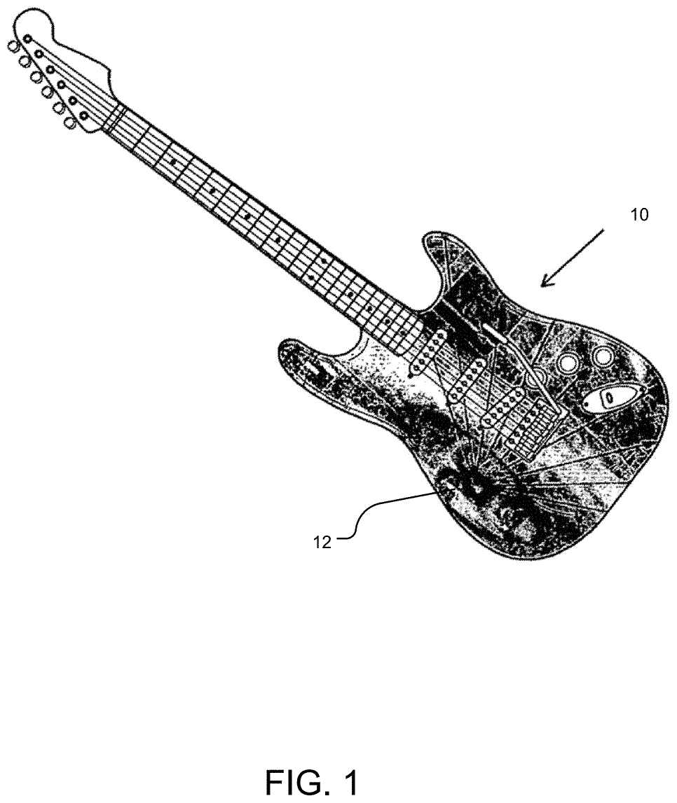

With further reference to the drawings, consider first an example guitar 10 and design 12. FIG. 1 shows a perspective view of an example guitar 10 that is decorated in accordance with one embodiment of the present disclosure. The guitar 10 generally represents a flat-bodied or contoured top stringed musical instrument having a long-fretted neck and usually six strings that may be plucked with a pick or with the fingers, for example. The guitar 10 may include either an electric guitar or an acoustical guitar.

As shown, the guitar 10 may be adorned with a design 12 applied over a surface thereof. In the illustrated embodiment of the present disclosure, the design 12 may be applied over a surface of a body of the guitar 10. It is not required that the design 12 be applied to the body of the guitar 10, or to only the body of the guitar 10. For instance, other parts of the guitar, such as the neck and/or the back may also optionally be provided with the design 12 and/or another design different than that applied to a front body of the guitar.

The illustrated design may include color graphics, which for convenience are represented as grayscale in FIG. 1. The color graphics may include a photographic quality representation of a digital image. The digital image may include a representation of a face and other computer-generated graphics (e.g., arrows). However, it will be appreciated that the particular design illustrated is not required. Other suitable decorations may include photographs, graphical arts, logos, words, or the like without limitation.

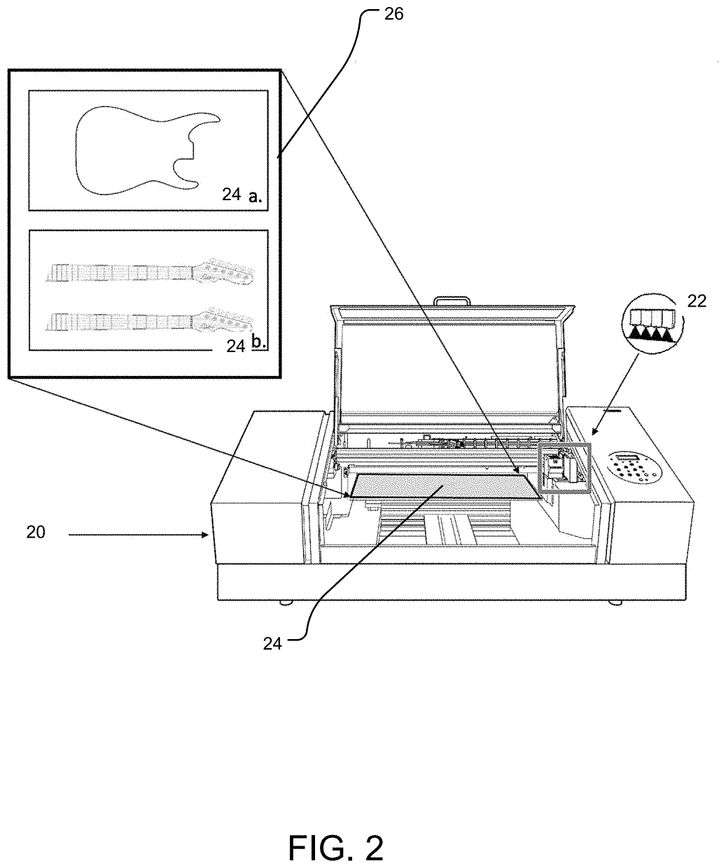

FIG. 2 shows a cross-sectional view of an example of a printing apparatus 20. In an example, the printing apparatus 20 may be a desktop UV flatbed printing apparatus. In any regard, the printing apparatus may include a plurality of ink-jet spray nozzles 22 spraying or otherwise applying a radiation sensitive UV ink composition. The plurality of ink-jet spray nozzles 22 are shown in a detailed inset in FIG. 2. The radiation sensitive UV ink may be applied (e.g., printed) to a transfer material 24. A detailed inset showing a perspective view of a print-bed 26 comprising a standardized flatbed area for holding the transfer material is also shown. The print-bed 26 may accommodating one or both of a transfer material 24a for a design for one guitar body or a transfer material 24b for two guitar necks. However, in other embodiments, a print bed 26 may accommodate one or more portions of transfer material that may include any combination of templates for various components of a guitar. That is, the print bed 26 may accommodate a transfer material 24 on which a design for a guitar body is printed, the print bed 26 may accommodate two transfer materials 24 on each of which a design for a guitar body is printed, etc.

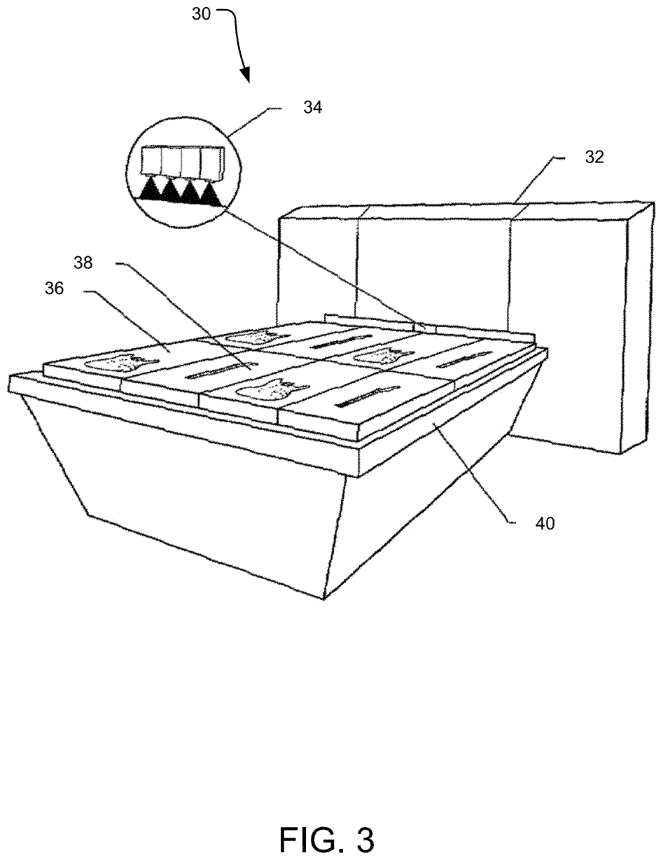

FIG. 3 shows a perspective view of another printing apparatus 30, according to an example of the present disclosure. The printing apparatus 30 may include a jet-printing device 32 comprising a plurality of ink-jet spray nozzles of a printheads 34 of the jet printing device 32 (shown in a detail inset in FIG. 3). The printing apparatus 30 may also include a plurality of standard-sized forms of transfer materials 36 with vectors 38 in the shape of the design for transfer to a guitar. The transfer materials 36 are provided on a 40 in the illustrated example, but the transfer material could also be applied to a roll-style printer, to receive the plurality of standard-sized forms of transfer material. An integrated digital graphics computer interface (not shown) may be provided. The integrated digital graphics computer interface may control the printing device 32 to cause the printhead 34 to spray a design onto the positioned transfer material 36. In addition, a radiation source (not shown) such as a UV lamp or the like may be provided to expose printed UV radiation sensitive ink to UV light once the design has been printed onto the transfer material 36. The exposure to UV radiation may partially cure the UV sensitive ink on the transfer material 36.

In one example of the present disclosure, the printing apparatus may include a high-speed jet-printing apparatus such as a UV ink-jet printer. A variety of UV ink-jet printers are commercially available from numerous sources. Suitable UV ink-jet printers include, but are not limited to, a Durst Rho 160, available from Durst Dice America, of Rochester, N.Y.; a 3M® Printer 2500 UV, available from 3M Commercial Graphics Division, of St. Paul, Minn.; an Inca Eagle 44, available from Sericol Imaging, of Kansas City, Kans.; a Leggett and Platt Virtu, available from Leggett & Platt Digital Technologies, of Jacksonville Beach, Fla.; a Scitex VeeJet, available from Scitex Vision America Inc., of Marietta, Ga.; a PressVu UV™ 180/600 EC or PressVu UV™ 180/360 EC, both available from VUTEk, Inc., of Meredith, N.H.; or a Zund Uvjet 215, available from ACCI, of Edina, Minn. Another example of a printer may be a UJF-605C Flatbed UV. Inkjet Printer, available from Mimaki Engineering Co., LTD, of Tokyo, Japan. Further still, the printing apparatus may comprise a Roland LEC 330, Roland LEC 2 330, Roland VersaUV S-Series UV-LED Flatbed Printer available from Roland DG UK of Clevedon, UK; a Roland VersaUV LEJ-640FT Large-Format UV Flatbed Printer available from Roland DGA Corporation of Irvine, Calif.; or a Mimaki® UJF-6042 MkII Tabletop, the UJF-3042 MkII Tabletop UV-LED Flatbed printer available from Mimaki Engineering Co. Ltd. of Suwanee, Ga. Further still, the printing apparatus may comprise a LEC2-300S S-series Flatbed Printer.

Prior to printing on the transfer material, a digital image may be loaded into the printing apparatus. In this regard, the printing apparatus may include an integrated digital graphics computer interface. In one aspect, in addition to accessing the digital image, a shape file corresponding to a shape of a guitar or guitar part to be printed onto the transfer sheet may be accessed. Different files may be provided for different types of guitars, such as Stratocaster®, V-shape, or the like. The integrated digital graphics computer interface may rasterize the digital image for printing by the printing apparatus. A printer driver may be used for this purpose. Then, the rasterized representation of the digital image may be used by the integrated digital graphics computer interface, or another suitable controller, to control the printing or other application of the decoration onto the transfer material by the ink-jet spray nozzles.

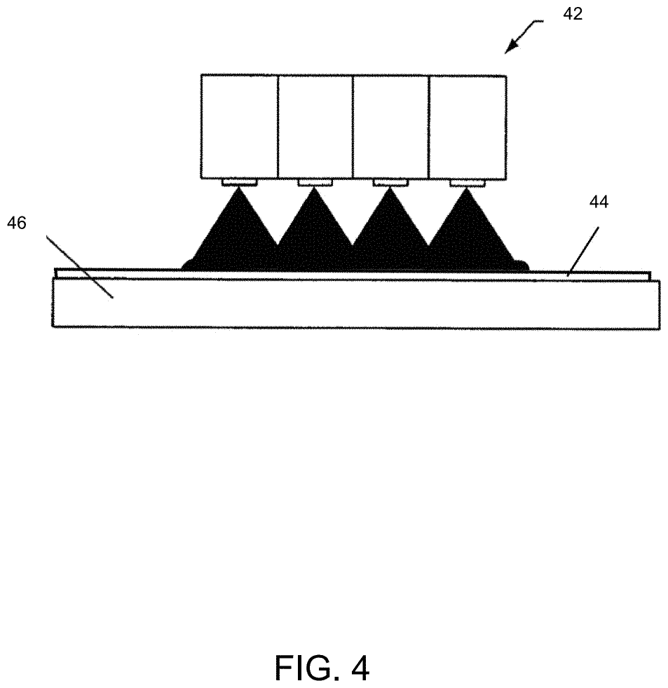

FIG. 4 shows a cross-sectional view of a plurality of ink-jet spray nozzles 42 spraying or otherwise applying a radiation sensitive ink composition over a surface of a transfer material 44 positioned on a bed of the printer 46 or from a roll, according to one embodiment of the present disclosure. It should be noted that terms such as “over”, “top”, “bottom”, “upper” “lower”, “vertical”, “horizontal”, and the like, are used herein to facilitate the description of the structures as illustrated. It will be evident that the structures may be used in a variety of orientations.

As will be explained in further detail below, in examples of the present disclosure, a design may be formed over the surface of the guitar by transferring the design comprising partially cured radiation sensitive ink to a guitar body. The radiation sensitive ink, once printed on the transfer material may be partially cured by polymerizing and cross-linking the radiation sensitive ink by exposing the transfer material and radiation sensitive ink to appropriate actinic radiation. The design on the transfer material may include a solid, cross-linked, polymerized, radiation-partially-cured ink prior to transfer to the guitar body.

The partially cured radiation sensitive ink may be placed in contacting engagement with the guitar body by disposing the transfer material into facing engagement with the guitar body. That is, the surface on which the partially cured radiation sensitive ink is printed may be moved into facing engagement with the guitar body. This may include aligning the transfer material with the guitar body to register the design printed on the transfer material relative to the guitar body.

The use of a transfer material containing radiation sensitive (e.g., UV sensitive) ink which is partially cured may offer a number of potential advantages. Once fully cured, the decorations applied by such a transfer printing process tends to be durable and high quality. The transfer process works well on wood and on polymers of the type and can be used to manufacture or coat guitars and other stringed musical instruments. In addition, the transfer printing process generally employs low or no levels of solvents, which tends to lessen the environmental impact, solvent emissions, and occupational health risks associated with inhalation of vapors.

Due at least in part to the polymerization provided by cured radiation sensitive inks, the design tends to be quite durable. However, in some examples, an optional coating may often be formed over the decoration in order to help protect the decoration from wear, and enhance the gloss, sheen, and other visual attributes of the guitar. The coating is often referred to in the arts as a topcoat. Commonly employed topcoats include polyurethane coatings and lacquer coatings, such as shellac coatings and nitrocellulose coatings. The radiation sensitive ink may include cross-links with many common materials used for such topcoats, making the resulting design very durable. In this regard, protective or top coatings may make the decoration more durable, so as to withstand years of use and retain its beauty. Also, the guitar may be cleaned repeatedly without removing or scratching the decoration.

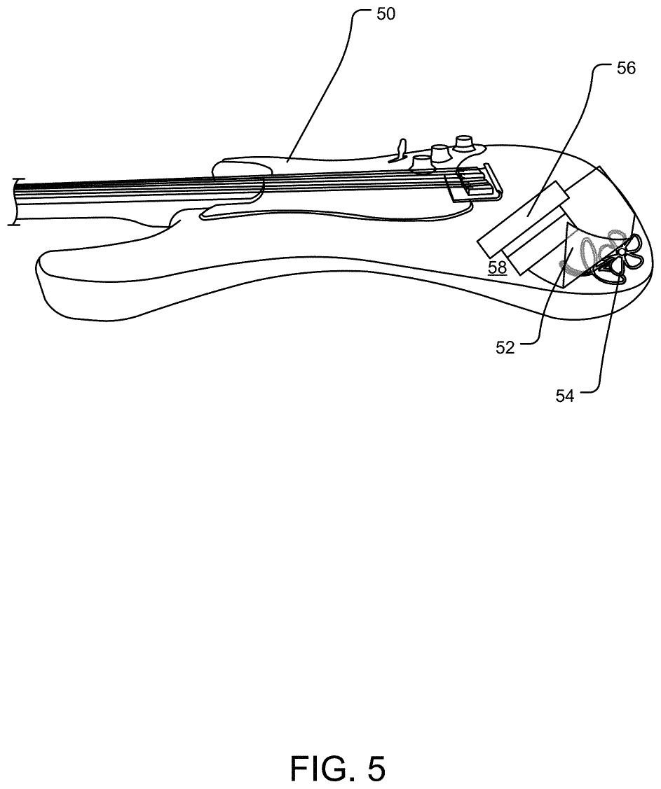

With further reference to FIG. 5, an example method of transferring a to a surface of a guitar from a transfer material is illustrated. As described above, a guitar 50 having a contoured surface 58 may have disposed relative thereto a transfer material 52 on which a design 54 has been printed using radiation sensitive ink. The design 54 may be partially cured on a surface of the transfer material 52 on which the radiation sensitive ink has been printed. The transfer material 52 may be optionally aligned or otherwise registered with the contoured surface 58 such that the surface of the transfer material 52 on which the design 54 has been printed and partially cured is in facing engagement with the contoured surface 58. This, in turn, disposes the design 54 between the transfer material 52 and the contoured surface 58. In turn, a rub down process in which pressure is applied to the transfer material 52 (e.g., using a felt tip burnisher 56) may result in the design 54 being applied to the contoured surface 58 to apply the design to the body of the guitar 50. In an example, the alignment may be accomplished by a jig. The jig, for example, may have registration hardware that is used to align the transfer material with the guitar. As an example, the registration hardware may include pins and holes that are alignable to register the jig, and therefore the transfer material, relative to the guitar body.

In providing the portion of the guitar, in one embodiment of the present disclosure, a conventionally produced portion of a guitar, such as a guitar body or a guitar neck, may be provided. In one aspect, the portion of the guitar may include a carved or otherwise machined, and optionally sanded, wood guitar body or neck. Exemplary woods conventionally used in the manufacture of guitars include, but are not limited to, alder, poplar, mahogany, and maple. The use of wood in the manufacture of guitars is prevalent, although the present disclosure is not so limited. In another aspect, the portion of the guitar may include a molded or otherwise formed, and optionally sanded, plastic guitar body or neck. Other materials and conventional portions of the guitars may also optionally be employed.

In one application, the decoration may be applied directly on a surface of the wood or other material of construction of the guitar.

The one or more coatings may include one or more acrylic coatings, polyurethane coatings, polyester coatings, lacquer coatings (e.g., shellac, nitrocellulose, etc.), lacquer paints, or a combination of such coatings. Embodiments of the present disclosure are not limited to any known coating or combination of coatings. Additionally, in an embodiment of the present disclosure, the decoration may be applied directly to either an acrylic, poly-urethane, polyester, or lacquer coating on the surface of the guitar.

For example, in one example, a multiple-layer coating may be formed over the wood surface of the guitar, prior to applying the decoration. Initially, a surface of a conventionally carved and sanded wood guitar body may be sealed. A layer or coating of a sealant may be formed over the surface of the wood. Suitable sealants include, but are not limited to, polyurethane coatings, polyester coatings, acrylic coatings, and lacquer coatings (e.g., shellac coatings or nitrocellulose coat-ings). If desired, multiple coats may be used. Then, after sealing the surface, an optional layer of lacquer or urethane paint, or another type of conventional, commercially available paint, may be formed over the sealed surface. The paint may have any desired color, such as black, blue, red, purple, white, or another desired color. Next, if the optional layer of paint is applied, another layer or coating of polyurethane, polyester, acrylic, or lacquer (e.g., shellac or nitrocellulose) may optionally be formed over the layer or coating of paint. A single coating or multiple coatings may be employed. In forming the above coatings or layers, spay-coating may be employed, as well as electrostatic spray coating, dip coating, roll coating, painting, or other coating methods known in the guitar manufacturing arts. Then, the decoration may be applied over the above-described multiple layer coating.

According to one example of the present disclosure, to help improve adhesion of the decoration, the decoration may be applied directly on a partially cured material that is partially cured prior to the design being applied. Suitable materials include, but are not limited to, tacky polyurethanes, tacky polyesters, tacky acrylics, and tacky lacquers (e.g., tacky shellac or tacky nitro-cellulose materials), or otherwise incompletely cured or incompletely hardened materials. Applying the decoration directly on such tacky or incompletely cured materials may also tend to enhance the adhesion of the decoration. Additionally, depending upon the particular material, the radiation and/or heat provided by the process used to apply the decoration may assist with curing the material. Accordingly, the radiation and/or heat may potentially tend to speed up the curing time.

According to another example of the present disclosure, a hardened curable material or other hard material may optionally be sanded or otherwise roughened. The roughening of the surface may tend to improve adhesion of the decoration. In one embodiment of the present disclosure, the surface may be rough-ened with 280 to 400 grain sandpaper, or the equivalent, to provide good adhesion.

According to yet another embodiment of the present disclosure, the decoration on the transfer material may be formed directly on a UV print primer coating. A suitable UV print primer coating is the 51209B print primer available from Northwest Coatings, of Oak Creek, Wis. The 51209B print primer includes a mixture of acrylate monomers and oligomers having a boiling point of greater than 200° C. and a vapor pressure of less than 1 mm Hg at 25° C. Other UV print primers may also optionally be employed. A coating of the UV print primer may be formed over the surface of the guitar. In one aspect, the primer may be sprayed over the wood surface of the guitar, or over a polyurethane coated, lacquer coated, or otherwise coated surface of the guitar. Painting, roll-coating, dip coating, and other methods of application may also optionally be employed. Printing the decoration directly on the UV print primer coating may tend to enhance the printing and adhesion of the decoration.

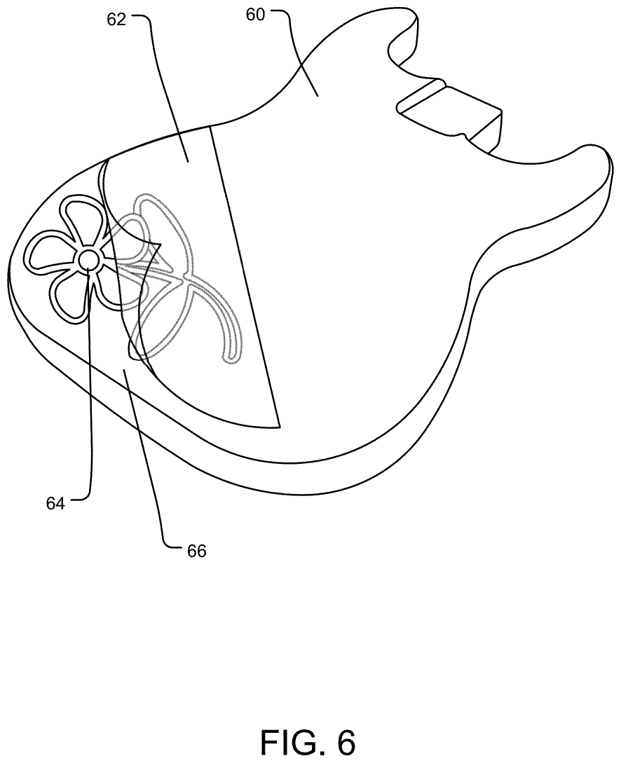

FIG. 6 illustrates an example of a transfer material 62 being peeled back and removed from the guitar body 60 with the transferred design 64 comprising the partially cured radiation sensitive ink being adhered to the guitar body 60 at the contoured surface 66.

As used herein, the term radiation sensitive ink composition refers to a composition including ink that is sensitive to radiation and capable of being chemically transformed by the radiation. As used herein, the term ink may broadly to any colorant and may include inks, dyes, pigment, other colorants (e.g., carbon black), or a combination. In one example of the present disclosure, the radiation-sensitive ink composition may include a UV radiation curable ink composition that is capable of being polymerized, preferably cross-linked, and at least partially solidified by UV radiation. The UV radiation may initiate a polymerization reaction, which may cause polymerization, for example cross-linking, of components in the composition in order to create the solid coating. A heat activated ink composition may also optionally be employed.

The UV radiation curable ink composition may include one or more monomers, oligomers, inks, and photo-initiators. The monomers often form the bulk of the composition and may be used to adjust the viscosity. In some cases, a mixture of monomers, such as monomers capable of giving polyesters and polyacrylates, may be employed. The oligomers often provide properties such as resistance and flexibility to the cured coating. The photo-initiator generally represents a molecule or other species that is sensitive to UV radiation and that is capable of initiating a polymerization reaction when exposed to the UV radiation. The compositions generally contain low levels of solvents or are solvent free. This may offer certain environmental and occupational health advantages to name a few.

Suitable UV radiation curable ink compositions are commercially available from numerous sources. One suitable composition includes the UV curable ink-jet ink called Uvi-jet, which is commercially available from Sericol Imaging, of Kansas City, Kans. Other suitable compositions are known in the arts.

In one embodiment of the present disclosure, a material used in an underlying layer may be combined with a UV curable ink-jet ink composition in order to give the UV curable ink-jet composition properties that are more similar to those of the underlying layer and allow the decoration to adhere better. For example, in various aspects, a polyurethane material, polyes-ter material, lacquer material (e.g., nitrocellulose or shellac), conventionally used in guitar manufacture may be included in the UV curable ink-jet composition in an amount of from about 1 to about 50 wt %, or 5 to 20 wt %, for example.

In the examples described herein (e.g., in FIG. 4 above), four nozzles or printheads are shown. In one example, the four nozzles may include separate nozzles for cyan, magenta, yellow, and black colored UV ink compositions. These inks are occasionally known in the arts as CMYK inks. In another embodiment of the present disclosure, the plurality of nozzles may include an additional nozzle for white. As will be explained further below, the white may, among other things, be useful for forming a mask layer over which an image may be applied to help mask underlying colors or features of the surface of the transfer material and improve image quality. In yet another alternate embodiment, the plurality may include additional nozzles for light magenta and light cyan. The provision of these additional colored UV ink compositions may help to improve image quality. Accordingly, in one example, the plurality may include seven nozzles, for cyan, magenta, yellow, black, white, light magenta, and light cyan. Other color combinations besides those based on CMYK may also optionally be employed.

The radiation sensitive ink may be sprayed on a surface of the transfer material using a print apparatus as described above such that the distance from the ink-jet spray nozzles or print-heads to the surface of the transfer material may be constant. In turn, the transfer material may be moved into position relative to a contoured portion of the guitar.

After the composition is sprayed on the surface of the transfer material, the radiation sensitive ink may be exposed to actinic radiation, for example UV radiation or light, to polymerize, cross-link, solidify, and cure the composition on the surface as a durable design. The printing apparatus may include a bulb, lamp, or other radiation source to provide the UV or other radiation. In the UV ink-jet printing arts, the radiation often includes UV radiation having a wavelength in the range of 200 to 400 nanometers (nm). The radiation may promote the polymerization, cross-linking, solidification, and curing process. In one aspect, the UV radiation may decompose the photo-initiators, which may include a number of well-known radiation-sensitive molecules. Then, the decomposed photo-initiators may initiate the polymerization reactions, which create long, often branched, and potentially cross-linked polymeric chains. The polymerization reactions, including the chain lengthening reactions, branching reactions, and cross-linking reactions, generally tend to cause the material to solidify rapidly. Often, depending upon the particular conditions, the material may solidify within a few seconds. Additionally, the approach tends to be economical and tends to be well suited for either small or larger volume manufacturing.

In one example of the present disclosure, the design may comprise a representation of an image that may include a dot matrix representation of the image formed by printing with one or more ink-jet spray nozzles. The dot matrix representation of the image may include a pattern of a plurality of dots substantially arranged in a grid. It will be appreciated that the grid may not be perfect. The term substantially arranged in a grid is meant to include at least the amount of deviation from a perfect grid that is customarily expected for a printer of the type used to form the decoration. Each of the plurality of dots may include a solid, polymerized, cross-linked material that may include one or more colored inks.

The printing speed may depend upon the resolution of the digital image. In one embodiment of the present disclosure, when using the UJF-605C Flatbed UV Inkjet Printer of Mimaki, it may be appropriate to employ print speeds of about 200 ft2/hr for 300 dpi, 55 ft2/hr for 600 dpi, and 20 ft2/hr for 1200 dpi.

In one embodiment of the present disclosure, to help increase the quality or appearance of the decoration, a mask may be printed in a radiation sensitive ink over the surface of the transfer material. In addition, a multi-color image may be printed in one or more radiation sensitive inks. The mask may be applied over the entire surface of the transfer material, or selectively over portions of the transfer material that are to receive the design, as desired. In one aspect, the mask may have substantially the same size, shape, and position as the image.

The mask may include a convenient, typically solid, background color. For example, the mask may include a substantially white color. The term substantially white is intended to include off-white colors including yellowish or grayish whites (e.g., ivory). One suitable substantially white radiation sensitive ink is XaarJet-71 WOO, available from Xaar pie, of Cambridge, United Kingdom. In one aspect, the mask may include a substantially white UV print primer composition.

Other colors, such as gray, blue, or black, for example, may also optionally be employed. Other substantially UV curable ink compositions are available from Mimaki, Durst, and Zund, to name a few.

Once the design has been applied to the surface of the transfer material, and the design has been transferred from the transfer material to the guitar, a topcoat may be applied to the surface of the guitar. Suitable topcoats include, but are not limited to, polyurethane, polyester, polyacrylic, and lacquer coatings. An example is PO LANE® High Solids Clear Top-coat polyurethane coating, available from The Sherwin-Williams Company, of Cleveland, Ohio. Another example is SHER-WOOD® CAB-Acrylic Lacquer from The Sherwin Williams Company. Yet another example is Lawrence-McFadden™ solvent-based nitrocellulose lacquer, available from The Lawrence-McFadden™ Company, of Philadelphia, Pa. If desired, multiple coats may be used. Then, the topcoat may be buffed to a shine.

One general aspect of the present disclosure includes a method for application of a design to a contoured surface of a guitar. The method includes providing a transfer material having a surface. The method also includes applying a design to the surface of the transfer material with a printing apparatus using a UV radiation sensitive ink. The method further includes exposing the UV radiation sensitive ink to UV light after the UV radiation sensitive ink has been applied to the surface of the transfer material to partially cure the UV radiation sensitive ink. In turn, the method includes disposing the surface of the transfer material in facing relation to the contoured surface to dispose the design between the surface and the contoured surface and transferring the design to the contoured surface.

Implementations may include one or more of the following features. For example, the transferring may include applying pressure to the transfer material on a side opposite the surface to apply the design to the contoured surface. The pressure may be applied as a rub down process using a burnisher to create friction to warm the design to release the design from the transfer material and engage the design with the contoured surface of the guitar.

In an example, the design may include a multi-colored rasterized representation of a digital image. In this regard, the applying the design may include spraying the UV radiation sensitive ink onto the surface of the transfer material using ink-jet spray nozzles of the printing apparatus according to the multi-colored rasterized representation of the digital image. The digital image may include a multi-colored photograph.

In an example, the method may also include aligning the transfer material with the contoured surface of the guitar.

In an example, the design may extend to substantially an entire top surface of the guitar at least including the contoured surface. That is, the design may also extend to portions of the guitar other than the contoured surface. In an example, the surface of the guitar including the contoured surface and at least one flat portion may be printed using the transfer material. In other examples, the design may extend to the contoured surface, and a flat portion of the guitar may be directly printed using the UV radiation sensitive ink. Thus, the method may include directly printing on another portion of the guitar different than the contoured surface.

Another general aspect of the present disclosure includes a method that includes providing at least a portion of a guitar having a contoured surface. The method also includes applying a design that comprises a multi-colored representation of a digital image to a transfer surface of a transfer material with a printing apparatus by spraying a radiation sensitive ink on the transfer surface of the transfer material with one or more ink-jet printheads of the printing apparatus. The method also includes exposing the radiation sensitive ink to radiation after the radiation sensitive ink has been sprayed on the transfer surface of the transfer material.

Implementations may include one or more of the following features. For example, the radiation may be provided from a radiation source of the printing apparatus.

In an example, the method may include disposing at least a portion of the transfer material on a moveable bed. The moveable bed may be controlled to direct the spraying of the radiation sensitive ink on the transfer surface to create the design on the transfer surface of the transfer material.

In an example, the method may include applying a mask to the contoured surface of the guitar. The mask may include a uniformly colored radiation sensitive masking ink applied to the contoured surface of the guitar. In this regard, the method may also include exposing the uniformly colored radiation sensitive masking ink to radiation in order to partially cure the uniformly colored radiation sensitive masking ink. The method may also include applying the design from the transfer surface to the contoured surface of the guitar prior to the uniformly colored radiation sensitive masking ink being completely cured. The mask may include a curable material and the method may include applying the design from the transfer surface to the contoured surface of the guitar prior to the curable material being completely cured. In another example, the method may include roughening the contoured surface of the guitar prior to applying the design from the transfer surface to the contoured surface of the guitar to promote adhesion between the partially cured radiation sensitive ink and the contoured surface of the guitar.

In an example, the method may include aligning the transfer material with the contoured surface of the guitar using a jig to register a guitar body with the transfer material. The jig includes at least one pin engageable by at least one hole disposed in the transfer material to register the transfer material relative to the guitar body.

In an example, the method may include directly printing on another portion of the guitar different than the contoured surface.

Another general aspect of the present disclosure includes a printing apparatus for application of a design to a contoured surface of a guitar. The printing apparatus includes a transfer material having a surface. The printing apparatus prints a design to the surface of the transfer material using a UV radiation sensitive ink. The printing apparatus may also include a UV radiation source used to expose the UV radiation sensitive ink to UV light after the UV radiation sensitive ink has been applied to the surface of the transfer material to partially cure the UV radiation sensitive ink. In turn, the surface of the transfer material is disposed in facing relation to the contoured surface to dispose the design between the surface and the contoured surface and the design is transferred to the contoured surface.

Another general aspect of the present disclosure includes a guitar having a contoured portion with a design applied thereto. The guitar may be produced by providing a transfer material having a surface, applying a design to a surface of a transfer material with a printing apparatus using a UV radiation sensitive ink, and exposing the UV radiation sensitive ink to UV light after the UV radiation sensitive ink has been applied to the surface of the transfer material to partially cure the UV radiation sensitive ink. In turn, the production may include disposing the surface of the transfer material in facing relation to the contoured surface to dispose the design between the surface and the contoured surface and transferring the design to the contoured surface.

In the description above, for the purposes of explanation, numerous specific details have been set forth in order to provide a thorough understanding of the embodiments of the present disclosure. It will be apparent, however, to one skilled in the art, that other embodiments may be practiced without some of these specific details. In other instances, well-known structures, devices, and techniques have been shown in block diagram form or without detail in order not to obscure the understanding of this description.

Many of the methods are described in their most basic form, but operations may be added to or deleted from the methods. For example, in one embodiment of the present disclosure, an old or used conventionally manufactured guitar may be decorated using this present disclosure. It will be apparent to those skilled in the art that many further modifications and adaptations may be made. The particular embodiments are not provided to limit the present disclosure but to illustrate it. While the present disclosure has been described in terms of several embodiments, those skilled in the art will recognize that the present disclosure is not limited to the embodiments described but may be practiced with modification and alteration within the spirit and scope of the appended claims. The description is thus to be regarded as illustrative instead of limiting. The scope of the present disclosure is not to be determined by the specific examples provided above but only by the claims below.

It should also be appreciated that reference throughout this specification to “one embodiment” or “an embodiment” means that a particular feature may be included in the practice of the present disclosure. Similarly, it should be appreciated that in the foregoing description of exemplary embodiments of the present disclosure, various features are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed present disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this present disclosure.

In the claims, any element that does not explicitly state “means for” performing a specified function, or “step for” performing a specified function, is not to be interpreted as a “means” or “step” clause as specified in 35 U.S.C. Section 112, Paragraph 6. In particular, the use of “step of” in the claims herein is not intended to invoke the provisions of 35 U.S.C. Section 112, Paragraph 6.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A method for application of a design to a contoured surface of a guitar, comprising:
providing a transfer material having a surface; and
applying a design to the surface of the transfer material with a printing apparatus using a UV radiation sensitive ink;
exposing the UV radiation sensitive ink to UV light after the UV radiation sensitive ink has been applied to the surface of the transfer material to partially cure the UV radiation sensitive ink;
disposing the surface of the transfer material in facing relation to the contoured surface to dispose the design between the surface and the contoured surface; and
transferring the design to the contoured surface.

2. The method of claim 1, wherein the transferring comprises application of pressure to the transfer material on a side opposite the surface to apply the design to the contoured surface.

3. The method of claim 2, wherein the pressure is applied as a rub down process using a burnisher to create friction to warm the design to release the design from the transfer material and engage the design with the contoured surface of the guitar.

4. The method of claim 1, wherein the design comprises a multi-colored rasterized representation of a digital image.

5. The method of claim 4, wherein the applying the design comprises spraying the UV radiation sensitive ink onto the surface of the transfer material using ink-jet spray nozzles of the printing apparatus according to the multi-colored rasterized representation of the digital image.

6. The method of claim 4, wherein the digital image comprises a multi-colored photograph.

7. The method of claim 1, further comprising:
aligning the transfer material with the contoured surface of the guitar.

8. The method of claim 7, wherein the design extends to substantially an entire top surface of the guitar at least including the contoured surface.

9. The method of claim 7, wherein the design extends to the contoured surface, and wherein a flat portion of the guitar is directly printed using the UV radiation sensitive ink.

10. The method of claim 1, further comprising:
directly printing on another portion of the guitar different than the contoured surface.

11. A method comprising:
providing at least a portion of a guitar having a contoured surface; and
applying a design that comprises a multi-colored representation of a digital image to a transfer surface of a transfer material with a printing apparatus by spraying a radiation sensitive ink on the transfer surface of the transfer material with one or more ink-jet printheads of the printing apparatus; and
exposing the radiation sensitive ink to radiation after the radiation sensitive ink has been sprayed on the transfer surface of the transfer material.

12. The method of claim 11, wherein the radiation is provided from a radiation source of the printing apparatus.

13. The method of claim 11, further comprising:
disposing at least a portion of the transfer material on a moveable bed, wherein the moveable bed is controlled to direct the spraying of the radiation sensitive ink on the transfer surface to create the design on the transfer surface of the transfer material.

14. The method of claim 11, further comprising:
applying a mask to the contoured surface of the guitar.

15. The method of claim 14, wherein the mask comprises a uniformly colored radiation sensitive masking ink applied to the contoured surface of the guitar, and the method further comprises:
exposing the uniformly colored radiation sensitive masking ink to radiation in order to partially cure the uniformly colored radiation sensitive masking ink.

16. The method of claim 15, further comprising:
applying the design from the transfer surface to the contoured surface of the guitar prior to the uniformly colored radiation sensitive masking ink being completely cured.

17. The method of claim 14, wherein the mask comprises a curable material, and wherein the method further comprises:
applying the design from the transfer surface to the contoured surface of the guitar prior to the curable material being completely cured.

18. The method of claim 11, comprising roughening the contoured surface of the guitar prior to applying the design from the transfer surface to the contoured surface of the guitar to promote adhesion between the partially cured radiation sensitive ink and the contoured surface of the guitar.

19. The method of claim 11, further comprising:
aligning the transfer material with the contoured surface of the guitar using a jig to register a guitar body with the transfer material, wherein the jig includes at least one pin engageable by at least one hole disposed in the transfer material to register the transfer material relative to the guitar body.

20. The method of claim 11, further comprising:
directly printing on another portion of the guitar different than the contoured surface.

21. A printing apparatus for application of a design to a contoured surface of a guitar, comprising:
a transfer material having a surface, wherein the printing apparatus prints a design to the surface of the transfer material using a UV radiation sensitive ink; and
a UV radiation source used to expose the UV radiation sensitive ink to UV light after the UV radiation sensitive ink has been applied to the surface of the transfer material to partially cure the UV radiation sensitive ink;
wherein the surface of the transfer material is disposed in facing relation to the contoured surface to dispose the design between the surface and the contoured surface and the design is transferred to the contoured surface.

22. A guitar having a contoured portion with a design applied thereto, the guitar being produced by:
providing a transfer material having a surface; and
applying a design to a surface of a transfer material with a printing apparatus using a UV radiation sensitive ink;
exposing the UV radiation sensitive ink to UV light after the UV radiation sensitive ink has been applied to the surface of the transfer material to partially cure the UV radiation sensitive ink;
disposing the surface of the transfer material in facing relation to the contoured surface to dispose the design between the surface and the contoured surface; and
transferring the design to the contoured surface.
